(19) United States
(12) Patent Application Publication
(10) Pub. No.: US 2008/0031306 A1
(43) Pub. Date: Feb. 7, 2008

(54) Protective tube structure for thermometer

(75) Inventors: Tsuguo Yamada, Ichihara-Shi (JP); Hiroshi Hamaoka, Ichihara-Shi (JP); Takao Michinoshita, Kobe-Shi (JP)

Correspondence Address: BIRCH STEWART KOLASCH & BIRCH, PO BOX 747, FALLS CHURCH, VA, 22040-0747, US

(73) Assignees: Idemitsu Kosan Co., Ltd., Tokyo (JP); Okazaki Manufacturing Company, Kobe-Shi (JP)

(21) Appl. No.: 11/724,202

(22) Filed: Mar. 15, 2007

(30) Foreign Application Priority Data
Aug. 3, 2006 (JP) 2006-006293

(51) Int. Cl. G01K 1/00

(52) U.S. Cl. 374/208

(57) ABSTRACT

There is provided a protective tube structure for a thermometer in which a gap between an anti-vibration strip and a surface of a protective tube is eliminated to prevent corrosion of the protective tube, and the anti-vibration strip can be easily formed. The protective tube structure for a thermometer includes: a cylindrical portion 2; and one or more projected rims 3 formed into a spiral on an outer wall of a barrel of the cylindrical portion 2, and the projected rim 3 is formed by cutting an outer surface of a barrel of a cylindrical member.

### BACKGROUND OF THE INVENTION

1. Field of the Invention

The present invention relates to a protective tube structure for a thermometer that is mounted to a pipe wall or a container wall, and measures a temperature of a fluid flowing therein.

2. Description of the Related Art

When a temperature of a fluid flowing in a pipe is measured, generally, a cylindrical or a tapered cylindrical protective tube is mounted through a pipe wall, and a temperature sensor such as a thermocouple or a resistance thermometer detector is inserted in the protective tube to measure the temperature of the fluid.

However, if the thermometer protective tube is placed perpendicularly to the flow in the pipe in which the fluid flows at high speed, the thermometer protective tube may be subjected to flow-induced vibration due to a Karman vortex and damaged.

As known, the Karman vortex is a vortex alternately generated downstream of an object (the thermometer protective tube in this case) placed in a uniform flow, and the generation of the Karman vortex causes vibration of the thermometer protective tube. Fatigue caused by the flow-induced vibration (fatigue caused by synchronization of natural frequency of the thermometer protective tube and the Karman vortex shedding frequency) often becomes a cause of an accident.

A measure to prevent the vibration of the thermometer protective tube has been taken such as increasing a thickness of the thermometer protective tube, but the increase in thickness causes a slow response of the thermometer, and reduces measurement accuracy due to an influence of external temperature of a pipe on a measurement value.

Thus, as shown in FIG. 3, a protective tube structure has been proposed that prevents generation of a Karman vortex itself (see, for example, “Evaluation Guidelines of Flow-induced Vibration of Cylindrical Structure in Pipe” in the Japan Society of Mechanical Engineers standards (published in 1998) pp. B83 to B84).

The structure in FIG. 3 is formed by winding an anti-vibration strip 51 formed of an elongated flat plate or a streak material around a surface of a cylindrical structure (the thermometer protective tube in this case) 50 into a spiral, and design specifications of the anti-vibration strip 51 is as described below.

Height of the flat plate or streak material: 0.05 D to 0.12 D

The number of flat plates or streak materials: three spirals in parallel winding

Pitch of winding: 3.6 D to 5 D

where D is a diameter of the cylindrical structure 50.

Winding such an anti-vibration strip 51 causes an irregular vortex to be formed, thereby preventing vibration of the thermometer protective tube.

The anti-vibration strip 51 is often formed of a streak material, more specifically, a wire by reason that an existing material can be used. Three wires are wound around the surface of the thermometer protective tube 50 according to the above described design specifications, and secured to the surface of the thermometer protective tube 50 by TIG spot welding as shown in an enlarged view in FIG. 4. In FIG. 4, reference numeral 51a denotes a welding portion.

However, in the conventional thermometer protective tube 50, a gap is inevitably created between the anti-vibration strip 51 and the surface of the thermometer protective tube 50 in an unwelded area.

If the thermometer protective tube 50 with the gap is used for fluid temperature measurement in, for example, a petrochemical plant, impurities adhere to the gap to cause corrosion of the thermometer protective tube 50. Also, thermometer protective tube 50 with the gap is used in food manufacturing industry, accretion in the gap may become rotten and possibly be mixed in a product.

Further, if a fluid contains solid material, the solid material repeatedly hits against the anti-vibration strip 51, which may cause the anti-vibration strip 51 to peel off the surface of the thermometer protective tube 50.

In order to solve these problems, as shown in a side view in FIG. 5A and a cross sectional view taken in the direction of arrow C-C in FIG. 5B, welding of all contact portions between the thermometer protective tube 50 and a wound wire 52 as an anti-vibration strip, so-called all-around welding has been performed. However, the all-around welding takes long time and much labor, and further, a new problem arises that the thermometer protective tube 50 is more likely to be affected by thermal stress or thermal distortion by a long weld line. In FIGS. 5A and 5B, reference numeral 53 denotes a thermometer inserting hole, and reference numeral 54 denotes a welded portion.

### SUMMARY OF THE INVENTION

The present invention has been achieved in view of the above described problems in the conventional protective tube structure for a thermometer, and provides a protective tube structure for a thermometer in which a gap between an anti-vibration strip and a surface of a thermometer protective tube is eliminated to prevent corrosion of the thermometer protective tube, and the anti-vibration strip can be easily formed.

The present invention provides a protective tube structure for a thermometer including: a cylindrical portion; and one or more projected rims formed into a spiral on an outer wall of a barrel of the cylindrical portion, wherein the projected rim is formed by cutting an outer surface of a barrel of a cylindrical member.

In the present invention, the cylindrical member means unprocessed configuration of the cylindrical portion.

According to the present invention, the cylindrical portion and the projected rim can be integrally formed, and thus no gap is created between the cylindrical portion and the projected rim, thereby significantly reducing time for manufacturing the protective tube and labor as compared with the case of winding a wire and welding it by all-around welding. Also, thermal stress or thermal distortion due to welding does not occur, thereby providing a protective tube with high reliability.

In the present invention, the cylindrical portion may be formed in tapered shape which is narrowed toward a tip, and thus can be smoothly mounted to or removed from a pipe.

In the present invention, two corners on a top of the projected rim may be formed substantially at a right angle, and a bottom of the projected rim and the outer wall surface of the barrel of the cylindrical portion may be connected with a radius. Thus, the portion with the radius prevents adhesion of impurities, and the substantially right angle portions on the top of the ridge portion can effectively form an irregular flow for preventing a Karman vortex.

In the protective tube structure for a thermometer of the present invention, the anti-vibration strip is formed integrally with the cylindrical portion by cutting, and thus no gap is created between the anti-vibration strip and the surface of the protective tube, thereby preventing adhesion of impurities, and preventing corrosion of the protective tube caused by the impurities.

As compared with the case of all-around welding, manufacturing time can be significantly reduced, and further, no welding is performed, thereby eliminating the influence of thermal stress or thermal distortion and providing a protective tube with high reliability.

### BRIEF DESCRIPTION OF THE DRAWINGS

FIG. 1A is a side view, partially in section, of a configuration of a protective tube structure for a thermometer according to the present invention;

FIG. 1B is a cross sectional view taken in the direction of arrow A-A;

FIG. 2 is an enlarged view of a portion B in FIG. 1B;

FIG. 3 is a side view of a conventional protective tube structure that prevents generation of a Karman vortex;

FIG. 4 is an enlarged view of essential portions in FIG. 3;

FIG. 5A is a side view, partially in section, of another example of a conventional protective tube structure; and

FIG. 5B is a cross sectional view taken in the direction of arrow C-C.

### DETAILED DESCRIPTION OF THE PREFERRED EMBODIMENTS

Hereinafter, an embodiment of the present invention will be described in detail with reference to the drawings.

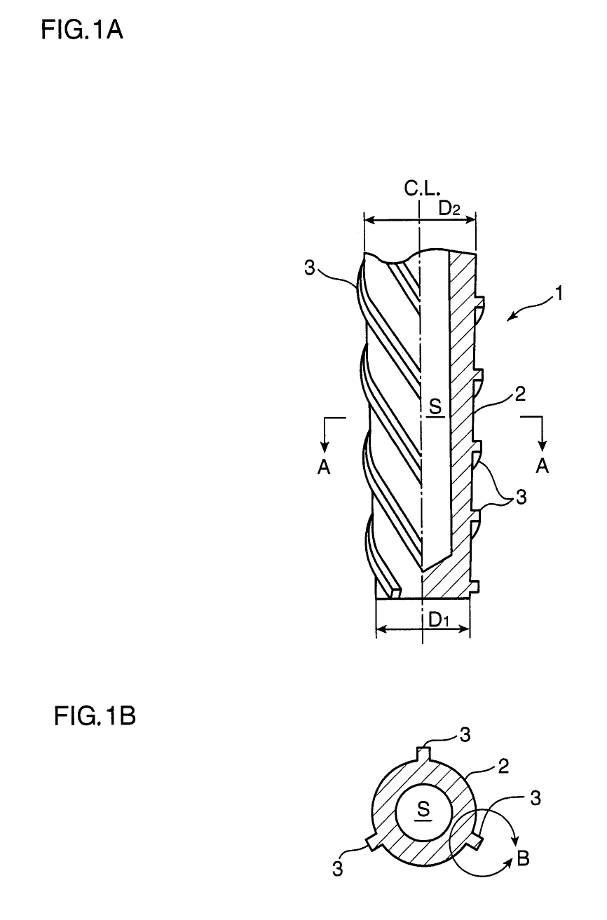

FIG. 1 shows an embodiment of a protective tube structure for a thermometer according to the present invention.

In FIG. 1A, the right half from the centerline C.L. shows a protective tube 1 in section, and the left half shows an appearance of the protective tube 1.

In FIGS. 1A and 1B, the protective tube 1 of the thermometer of the embodiment is made of SUS304, and includes a closed-end cylindrical portion 2, and projected rims 3 formed on an outer wall of a barrel of the cylindrical portion 2.

As shown in FIG. 1B, three projected rims 3 are circumferentially spaced at equal spaces, and formed into spirals in parallel with each other toward the tube axis direction of the cylindrical portion 2.

A cylindrical hole S is formed in the center of the cylindrical portion 2 (along the tube axis) to a predetermined depth so that a temperature sensor such as a thermocouple or a resistance temperature sensor is inserted therein.

The outer wall of the barrel of the cylindrical portion 2 is tapered (an outer diameter D₂ of a rear end of the cylindrical portion is larger than an outer diameter D₁ of a tip of the cylindrical portion) and narrowed toward the tip. This allows the cylindrical portion 2 to be smoothly mounted to or removed from a pipe (not shown in the figure).

The projected rim 3 corresponds to a wire wound around an outer wall of a barrel of a cylindrical portion in a conventional structure, and in the present invention, the spiral projected rim 3 is formed by cutting. The projected rim 3 functions as an anti-vibration strip that prevents generation of a Karman vortex.

Specifically, the protective tube 1 is formed into a cylindrical shape which is closed at one end by drilling a round rod, and in a barrel of the protective tube 1, an area between the projected rims 3 is cut into a groove using an end mill on a milling machine to form the projected rims 3 in streaks.

In the protective tube 1 thus formed by cutting, the projected rim 3 is formed integrally with the protective tube 1, and thus no gap is created between the protective tube and the wire as in the conventional wire mounting method by welding.

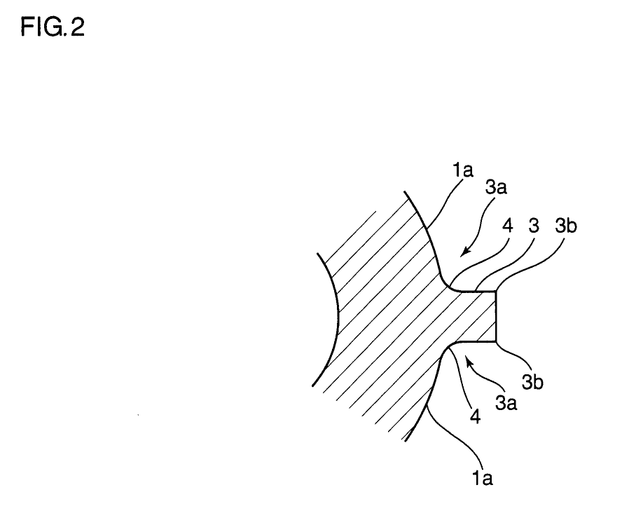

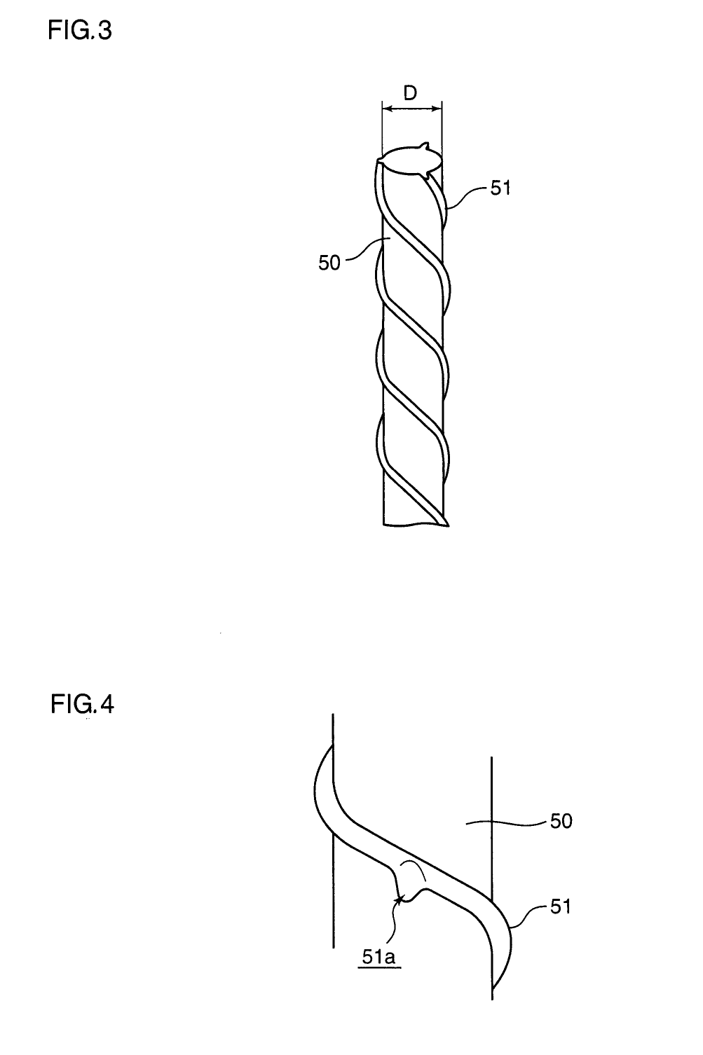

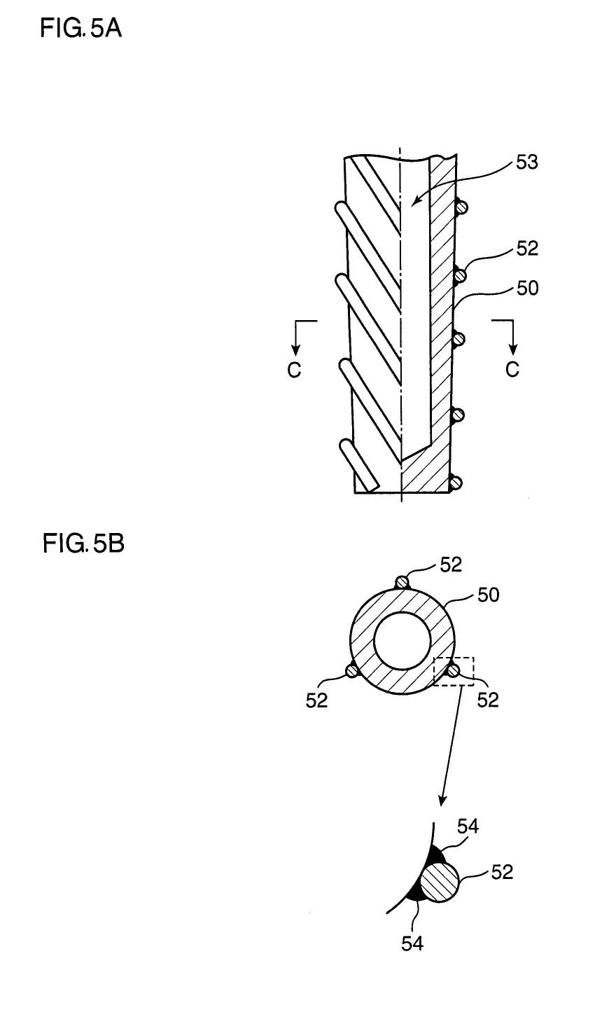

Further, as shown in an enlarged view in FIG. 2, the bottom 3a of the projected rim 3 is connected to an outer wall surface 1a of the barrel of the protective tube 1 with a radius 4 to form a smooth surface without a welding bead placed in a gap at a contact portion between the protective tube 1 and the wire as in the conventional all-around welding, thereby completely solving the problem of the conventional protective tube that adhesion of impurities causes corrosion.

On the other hand, on a top of the projected rim 3, opposite corners 3b and 3b are formed substantially at a right angle, and thus an irregular flow for preventing a Karman vortex is more effectively formed than the protective tube to which the wire having a circular section is welded.

### EXAMPLE

A round rod was drilled to form a protective tube 1 as a cylindrical member, and an outer wall of a barrel of the protective tube 1 was cut into a groove by an end mill to form projected rims 3 into spirals.

An outer diameter of the formed protective tube 1 (except the projected rim 3) was about φ20 mm (D), and a height of the projected rim 3 was 2 mm (about 0.1 D).

The projected rims 3 were formed into three spiral windings in parallel with each other, and a winding pitch was about 100 mm (about 5 D).

The protective tube 1 thus obtained was mounted to a pipe to be measured in a perpendicular to a flow of a fluid, a thermocouple was inserted into a cylindrical hole S in the protective tube 1, and the temperature of the fluid was measured.

It was confirmed that no impurity adheres to the projected rim 3 according to the protective tube 1 of the thermometer having the above described configuration.

In the embodiment, the protective tube 1 is made of SUS304, but not limited to this, the protective tube 1 may be made of, for example, SUS316, SUS316L, or other heat-resistant and corrosion-resistant steel or the like according to the use.

The foregoing description of at least one preferred embodiment of the invention has been presented for purposes of illustration and description. It is not intended to be exhaustive or to limit the invention to the precise form disclosed. Obvious modifications or variations are possible in light of the above teachings.

What is claimed is:

1. A protective tube structure for a thermometer comprising:
a cylindrical portion; and
one or more projected rims formed into a spiral on an outer wall of a barrel of the cylindrical portion,
wherein said projected rim is formed by cutting an outer surface of a barrel of a cylindrical member.

2. The protective tube structure for a thermometer according to claim 1, wherein said cylindrical member is formed in tapered shape which is narrowed toward a tip.

3. The protective tube structure for a thermometer according to claim 1, wherein opposite corners on a top of said projected rim are formed substantially at a right angle, and a bottom of said projected rim and the outer wall surface of the barrel of said cylindrical portion are connected with a radius.

4. The protective tube structure for a thermometer according to claim 2, wherein opposite corners on a top of said projected rim are formed substantially at a right angle, and a bottom of said projected rim and the outer wall surface of the barrel of said cylindrical portion are connected with a radius.
